(19) United States
(12) Patent Application Publication
(10) Pub. No.: US 2005/0233116 A1
(43) Pub. Date: Oct. 20, 2005

(54) Zone-coated poly ream wrapper

(76) Inventors: Lou Ann Mueller, Little Chute, WI (US); Michael R. Nowak, Hilbert, WI (US)

Correspondence Address: Philip M. Weiss, Esq.;Weiss & Weiss, Suite 251, 300 Old Country Road, Mineola, NY, 11501, US

(21) Appl. No.: 10/826,574

(22) Filed: Apr. 16, 2004

(51) Int. Cl. B32B 23/02

(52) U.S. Cl. 428/192

(57) ABSTRACT

A poly-coated paper ream wrapper that is coated or covered with varnish or other coating material in specific zones so as to prevent heat-sealing of the ream wrap to the packaged paper inside the wrapper, and a method for making the same.

### FIELD OF THE INVENTION

The present invention relates to a poly-coated paper ream wrapper that is coated or covered with varnish or other coating material in specific zones so as to prevent heat-sealing of the ream wrap to the packaged paper inside the wrapper.

### BACKGROUND OF THE INVENTION

Reams (i.e., 500 sheets) of cut paper (8½×11 in., etc.) for copy machines, computers, printers, and other applications are most commonly packaged for shipping, storage, and retail sale in ream wrappers made of various wrap materials. These wrap materials traditionally have been paper (poly-coated or two papers laminated with poly), plastic film, or a paper/solid film combination. In addition to encasing reams of paper, the wrap materials protect the wrapped paper product from physical damage and moisture pickup during shipping and storage. The wrap materials also protect the wrapped product from physical damage during handling and stocking on retail shelves.

A current disadvantage of ream wrappers made of poly-coated paper materials is that during the wrapping process, when the wrapper is subjected to thermal energy, heat, or other curing methods, the poly, which becomes tacky and seals the ends and back panels of the wrapper, also sticks to the paper packaged inside the ream. When this happens, the bottom sheet or sheets of paper are destroyed and must be discarded. The market demands a poly-coated paper wrapper that prevents the heat-sealed area from sticking to the bottom sheet(s) of paper encased in the ream.

To this end, the present invention prevents the poly-coated paper ream wrap from sticking to the bottom sheet(s) of paper along the back panel of the wrapper that is intended for heat-sealing.

The prior art product is made by coating, extruding, or otherwise covering one side of paper with a layer of polyethylene, low or high density polyethylene, or other polymer or poly resin. During the wrapping process, the wrapper is subjected to heat or other curing methods, which melt the poly slightly so as to become tacky. The tackiness of the poly enables the wrapper to seal itself in the folded end areas of the wrapper and along overlapped back panels across the girth of the wrapper. A major disadvantage of this type of wrapper is that the poly also sticks to the bottom sheet(s) of paper contained in the ream along the heat-sealed back panels.

### SUMMARY OF THE INVENTION

The present invention relates to a poly-coated paper ream wrap that is used for packaging paper products. The product is made by coating, extruding, or otherwise covering one side of paper with a layer of polyethylene, low or high density polyethylene, or other polymer or poly resin. The inside of the wrapper which is poly coated is then coated or otherwise covered with a varnish or other material in specific zones to prevent the poly coated wrapper from sticking to the paper touching the back panel of the wrapper. During the wrapping process, the wrapper is subjected to heat or other curing methods, which melt the poly slightly so as to become tacky. The tackiness of the poly enables the wrapper to seal itself in the folded end areas of the wrapper and along overlapped back panels across the girth of the wrapper, but it does not stick to the paper touching the back panel of the wrapper.

The present invention relates to a poly-coated paper ream wrapper comprising: a sheet of brown, white or other kraft paper with a basis weight of approximately 40 to 70 lbs. per 3,000 sq.ft.; a first layer of approximately 4-14 lbs. of polyethylene, low or high density polyethylene, or other polymer or poly resin; and a second layer of varnish or other coating material applied in specific zones of the inside web of the ream wrapper.

It is an object of the present invention for the second layer of varnish or other coating material to be applied in zones beginning approximately ½ to 1½ inches from both outside edges of the inside web of the ream wrap and along the length of the web or in specific zones that will contact the paper inside. It is an object of the present invention for the second layer of varnish or other coating material to be applied in a zone that is approximately 1 to 10 inches in width.

It is an object of the present invention for the first layer of polyethylene, low or high density polyethylene, or other polymer or poly resin to be extruded onto the paper substrate. It is an object of the present invention for the first layer of polyethylene, low or high density polyethylene, or other polymer or poly resin to be subjected to heat during a wrapping process which forms a heat seal along an overlapped back panel of the ream wrap packaging.

It is an object of the present invention for the second layer of varnish or other coated material to be applied during a printing, press, or other process involved in production of the ream wrapper and following poly extrusion or coating process. It is an object of the present invention for the second layer of varnish or other coating material to be applied beginning ½ to 1½ inches from the outer edges of the ream wrapper that are intended to overlap and form a heat-sealed back panel.

It is an object of the present invention for the zone-coated areas of varnish or other coating material to prevent heat-sealing of the back panel of the ream wrap to an inside sheet(s) of paper encased in the ream.

The present invention relates to a method of making a poly-coated paper ream wrapper comprising: extruding or coating a 40-70 lb. base paper substrate with 4-14 lbs. of polyethylene, low or high density polyethylene, or other polymer or poly resin across the inside web of the ream wrapper. A layer of varnish or other coating material is applied in specific zones along the length of the inside web of the ream wrapper or in specific zones that will contact the paper wrapped.

The present invention relates to a zone-coated poly-coated ream wrapper comprising: paper extruded with polyethylene, low or high density polyethylene, or other polymer or poly resin; and a second layer of varnish or other coating material applied in zones adjacent to an overlapped back panel area of the wrapper where a heat seal is intended to form. It is an object of the present invention for the zone to be approximately one to ten inches in width. It is an object of the present invention for the wrapper not to stick to the paper touching the back panel of the wrapper.

The present invention relates to a method for producing a ream wrap comprising: covering one side of a paper with a layer of polymer resin and placing in specific zones on top of the layer of polymer resin a layer of varnish or coating material which prevents the polymer resin coated wrapper from sticking to paper touching a back panel of the wrapper. It is an object of the present invention for the method to further comprise: heating or curing the wrapper and melting the poly to become tacky. The folded areas of the wrapper are sealed along overlapped back panels across the girth of the wrapper.

It is an object of the present invention for the product to be produced by coating or covering the poly-coated side of the paper in zones next to the overlapped back panels. It is a further object of the present invention to permit the poly-coated back panels adjacent to the coated zones to form a heat seal, but to prevent heat-sealing the outside of the back panel area. It is an object of the present invention to prevent the poly-coated wrapper from sticking to the bottom sheet(s) of paper as a result of the heat-sealing or curing process.

The present invention also relates to a poly-coated paper ream wrapper comprising: a first layer of polypropylene, low or high density polyethylene, or other polymer or poly resin, and a second layer applied over the poly coating in specific zones where the wrapper is not meant to heat-seal along the overlapped back panels of the packaging.

The present invention relates to a method of zone-coating so as to prevent the heat-sealing of the poly-coated wrapper to the bottom sheet(s) of paper encased in the ream.

The present invention relates to a method for producing a ream wrap comprising: covering one side of paper with a layer of polymer resin. The layer of polymer resin is covered with a material in specific zones to prevent the polymer resin coated wrapper from sticking to paper touching the back panel of the wrapper.

### BRIEF DESCRIPTION OF THE DRAWINGS

FIG. 1 shows an embodiment of the zone-coated, poly-coated paper ream wrap.

### DETAILED DESCRIPTION OF THE INVENTION

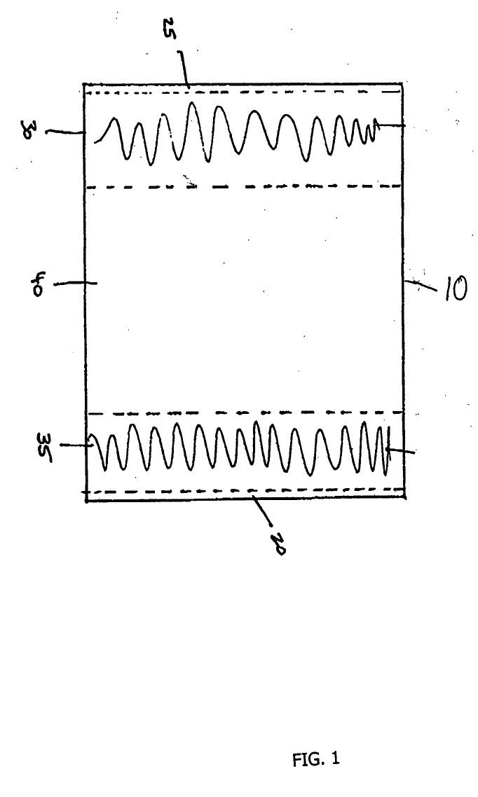

FIG. 1 shows an embodiment of the zone-coated, poly coated paper ream wrap material 10. FIG. 1 depicts the inside web of the zone-coated, poly-coated ream wrap 10 that is typically 20 to 28 inches wide. The ream wrap is produced by extruding or otherwise coating paper with a layer of approximately 4-14 lbs. of polyethylene, low or high density polyethylene, or other polymer or poly resin across the entire inside web of the wrapper. Typically, the basis weight of the underlying paper substrate comprises approximately 40-70 lbs. per 3,000 sq.ft. of white, brown, kraft or other paper.

Areas 20 and 25 depict the outer edges of the inside wrapper that are intended to overlap and form a heat-seal along the overlapped back panels of the packaging. Areas 20 and 25 are typically ½ inch to 1½ inches in width and form the overlapped back panels of the wrapped product. Areas 30 and 35, typically 1 to 10 inches in width, comprise areas adjacent to the back panels that are covered with a varnish or other coating material intended to prevent heat-sealing of the poly coating to the bottom sheet(s) of paper encased in the ream. Area 40 comprises the inside of the ream wrapper that consists of a layer of paper extruded with polyethylene or other polymer that is not zone-coated with the varnish or other coating.

The present invention comprises a zone-coated, poly-coated ream wrapper 10 comprising paper extruded with polyethylene, low or high density polyethylene, or other polymer or poly resin, and a second layer of varnish or other coating material applied in zones adjacent to the overlapped back panel area of the packaging where a heat seal is intended to form. The extruded coating is applied across the entire inside web of the zone-coated, poly-coated ream wrapper 10.

Areas 20 and 25 comprise the outer edges of the inside web of the ream wrap and constitute the overlapped back panel of the wrapper where a heat seal is intended to form during the wrapping process. Areas 30 and 35 comprise the zone-coated areas approximately 1 to 10 inches in width that are covered with a varnish or other coating material that prevents heat-sealing in the areas adjacent to the overlapped back panel of the packaging where the heat seal is formed. The zone-coated varnish or other coating material is applied during the printing or other processes of the ream wrap production following the poly extrusion or coating process.

Area 40 comprises the inside ream wrap area that is not zone-coated after the poly extrusion or coating process described above. Area 40 constitutes the remainder of the inside web that is not incorporated as part of the overlapped back panel forming the heat seal and that is outside of the zone-coated areas adjacent to the back panels.

In a further embodiment, the method of producing the present invention comprises: extruding or coating a 4-14 lb. layer of polyethylene, high or low density polyethylene, or other polymer or poly resin onto a paper substrate comprising brown, white, kraft or other paper with a basis weight of approximately 40-70 lbs. The poly-coated paper is then passed through a printer, press, or other apparatus that applies a varnish or other coating material in specified 1 to 10-inch zones along the length of the inside web of the ream wrapper 10.

1. A poly-coated paper ream wrapper comprising:
a sheet of brown, white or other kraft paper with a basis weight of approximately 40 to 70 lbs. per 3,000 sq.ft.;
a first layer of approximately 4-14 lbs. of polyethylene, low or high density polyethylene, or other polymer or poly resin;
a second layer of varnish or other coating material applied in specific zones along the length of the inside web of said ream wrapper.

2. The poly-coated paper ream wrapper of claim 1 wherein said second layer of varnish or other coating material is applied in zones approximately 2 to 1½ inches from both outside edges of the inside web of said ream wrap and along the length of said web or in zones along the length of said web.

3. The poly-coated paper ream wrapper of claim 1 wherein said second layer of varnish or other coating material is applied in a zone that is approximately 1 to 10 inches in width.

4. The poly-coated paper ream wrapper of claim 1 wherein the first layer of polyethylene, low or high density polyethylene, or other polymer or poly resin is extruded onto said paper substrate.

5. The poly-coated paper ream wrapper of claim 1 wherein said first layer of polyethylene, low or high density polyethylene, or other polymer or poly resin is subjected to heat during a wrapping process which forms a heat seal along an overlapped back panel of said ream wrap packaging.

6. The poly-coated paper ream wrapper of claim 1 wherein said second layer of varnish or other coated material is applied during a printing, press, or other process involved in production of said ream wrapper and following poly extrusion or coating process.

7. The poly-coated paper ream wrapper of claim 2 wherein said second layer of varnish or other coating material is applied adjacent to the ½ to 1½ inch outer edges of the inside web of said ream wrapper that are intended to overlap and form a heat-sealed back panel.

8. The poly-coated ream wrapper of claim 1 wherein the zone-coated areas of varnish or other coating material prevent heat-sealing of the back panel of said ream wrap to an inside sheet(s) of paper encased in said ream.

9. A method of making a poly-coated paper ream wrapper comprising:
extruding or coating a 40-70 lb. base paper substrate with 4-14 lbs. of polyethylene, low or high density polyethylene, or other polymer or poly resin across inside web of said ream wrapper;
applying a layer of varnish or other coating material along the full length or in specific zones along the length of said inside web of said ream wrapper.

10. A zone-coated poly-coated ream wrapper comprising:
paper extruded with polyethylene, low or high density polyethylene, or other polymer or poly resin; and
a second layer of varnish or other coating material applied in zones adjacent to an overlapped back panel area of said wrapper where a heat seal is intended to form.

11. The wrapper of claim 10 wherein said zone is approximately one to ten inches in width.

12. The wrapper of claim 10 wherein said wrapper does not stick to paper touching said back panel of said wrapper.

13. A method for producing a ream wrap comprising:
covering one side of a paper with a layer of polymer resin;
placing in specific zones on top of said layer of polymer resin a layer of varnish or coating material which prevents said polymer resin coated wrapper from sticking to paper touching a back panel of said wrapper.

14. The method of claim 13 further comprising:
heating or curing said wrapper;
melting said poly to become tacky;
sealing folded areas of said wrapper along overlapped back panels across girth of said wrapper.
